(19) United States
(12) Patent Application Publication
(10) Pub. No.: US 2026/0205666 A1
(43) Pub. Date: Jul. 16, 2026

(54) INTELLIGENT PLATFORM THAT CAN BE WATCHED AND RATE MOVIE AND CREATE AND USE MOVIE- SPECIFIC NFT

(71) Applicant: Ahmet Muhammed Tas, Batman (TR)

(72) Inventors: Ahmet Muhammed TAS, Batman (TR); Firat TAS, Batman (TR)

(73) Assignees: Ahmet Muhammed TAS, Batman (TR); Ahmet Muhammed Tas, Batman (TR)

(21) Appl. No.: 19/138,138

(22) PCT Filed: Dec. 16, 2022
(86) PCT No.: PCT/TR2022/051520

§ 371 Date: Jun. 12, 2025

(30) Foreign Application Priority Data
Dec. 12, 2022 (TR) 2022019066

(51) Int. Cl. H04N 21/475; G06Q 20/36; H04N 21/433; H04N 21/466; H04N 21/4722; H04N 21/488; H04N 21/81

(52) U.S. Cl. CPC H04N 21/4756; G06Q 20/367; H04N 21/4334; H04N 21/4668; H04N 21/4722; H04N 21/4884; H04N 21/812; H04N 21/8133

(57) ABSTRACT

In the vision of World Cinema Vision entered the time and date the application in the film that are purchased through monitoring, enabling crypto currency, an intelligent platform allows for the movie to be made available in the market and this special NFT able to offer integrated cold wallet, individuals with disabilities the opportunity to watch the film and analyze biological responses of the individuals who created the feeling watched a movie that can offer personalized suggestions can be graded according to the state of film and film special is that are related to NFT can be used to create intelligent platform.

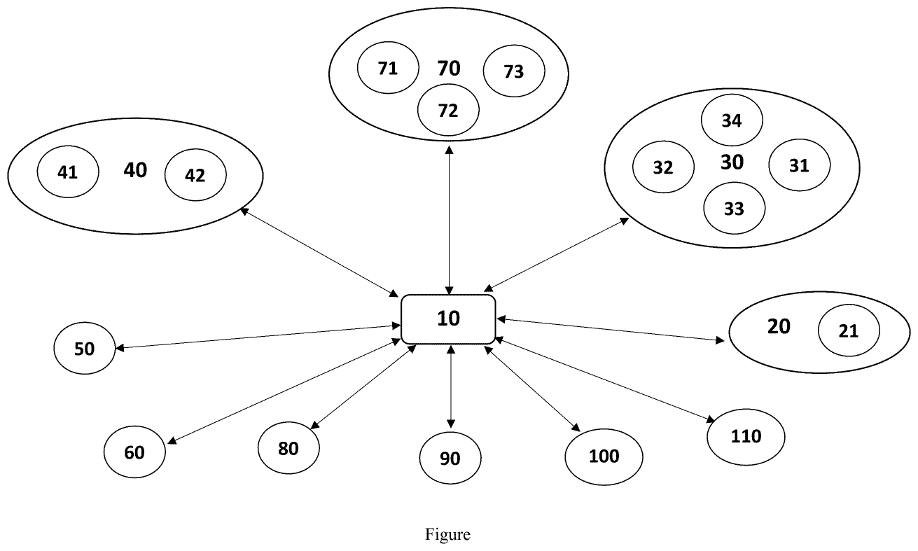

### CROSS REFERENCE TO THE RELATED APPLICATIONS

This application the national phase entry of International Application No. PCT/TR2022/051520, filed on Dec. 16, 2022, which is based upon and claims priority to Turkish Patent Application No. 2022/019066, filed on Dec. 12, 2022, the entire contents of which are incorporated herein by reference.

### TECHNICAL FIELD

This invention is related to a smart platform that allows movies released in world cinemas to be purchased and watched via the application at the time and date of vision, integrated with cold wallets that allow making movie-specific NFTs and offering it for sale on crypto currency exchanges, creating the opportunity to watch movies for people with disabilities, analyzing individuals'biological reactions and offering movie recommendations based on personalized mood, the movie can be watched and rated, and the movie-specific NFT can be created and used.

### BACKGROUND

The NFTs currently used are usually related to Non-Exchangeable Tokens (NFTs) and more specifically to NFT-based live artworks. NFTs are “one-of-a-kind” assets that can be bought and sold in the digital world like any property, but they do not have a concrete form of their own. NFTs are considered as certificates of ownership for virtual or physical assets. The following describes various programs used to create NFTs.

The patent application number US2022385468 describes “Pixel Streamed NFT-Based Living Artwork and Queue-Based Live Event Viewing”. A method provides a set of credentials for accessing a live event as a spectator. The credentials includes tiered credentials with respect to access privileges from a queue imposed to access the live event. The access privileges specify a queued order-based spectator access time and a spectator access duration. The method evaluates the credentials received from users seeking to access the live event as spectators including determining whether a provided credential pertains to a non-owning viewer or an owning viewer of a subject of the live event. The method controls, by a real-time visual media generation engine of a streaming server, the spectator access time, and the spectator access duration of each of the users to the live event as the spectators based on the credentials by placing the users in predetermined queuing positions associated with corresponding levels of the credentials. The live event is a living artwork.

The patent application number KR20220157923 describes “NFT Integrated Management System For NFT-Based Consumer and Manufacturer Collaboration Products”. According to various embodiments, the integrated management server for a collaboration product between a user and a manufacturer using a block chain includes a creator selection unit that determines a creator who will design the product in collaboration with the manufacturer; a DB management unit acquiring product information of the product from the manufacturer terminal of the manufacturer; A product tokenization unit that obtains a product registration request signal from the manufacturer terminal and generates at least one first NFT (Non-Fungible Token) corresponding to the product based on a first digital file for the product; A transaction intermediary unit for mediating a transaction for the first NFT generated through the blockchain network; A service operation unit that provides a royalty to the creator and the manufacturer may be included.

The patent application number CN114820862 describes “NFT image generation method, device and equipment”. The invention discloses an NFT image generation method, device and equipment, and the method comprises the steps: obtaining a layer material library folder which comprises a plurality of layer files, and each layer file comprises a plurality of NFT layer elements with numbers and/or names; the different layer files are subjected to relation binding according to a preset layer element matching rule, at least one element combination is generated, and each NFT layer element only appears in one element combination; and setting the binding relationship between the layer files as the highest priority, setting image generation parameters of the layer files, and automatically generating an NFT image by adopting a random principle. According to the method and the device, the image layer files can be bound into groups according to the preset matching rule, and the NFT image is randomly generated by taking the binding relationship as the highest priority in the image generation process, so that the NFT image of a complex image layer can be quickly and accurately generated, and the content error of the generated NFT image caused by disordered image layer attributes is avoided.

The programs used for NFT creation are described above. As noted, NFT systems and models do not include any features or models for use in the filmmaking industry (creating, sharing, buying, or selling NFTs). While watching movies through applications, there is no application such as creating, sharing, selling or buying an NFT of any scene by recording it.

As a result, the above-mentioned film enthusiasts, which can overcome the disadvantages that allows you to watch films in theaters for movie fans, where can I buy NFT as soon as it enters with a record of users on the platform by taking the stage as their own NFT specially created by users or purchased from the platform such as social media accounts and other platforms NFT create your own crypto currency available in the market is able to offer that it can share there is a need for a new platform.

### SUMMARY

This invention is an intelligent platform that can be watched and scored movies and can be used to create and use a movie-specific NFT, its feature is; that allows you to watch movies in theaters for movie lovers movie NFT where fans can buy as soon as it enters with a record of users on the platform by taking the stage as their own NFT specially created by users or purchased from the platform such as social media accounts and other platforms NFT create your own crypto currency can share it on a new platform that is able to offer is that it is available in the market.

In order to realize all the purposes mentioned above and which will be revealed from the detailed description below, the invention; the platform includes a cryptocurrency payment method that adds features different from other platforms. In addition to normal payment methods such as credit card or virtual card, using the 3D security method to ensure the security of the user, also the user can purchase movies and NFTs using crypto money.

The invention includes scoring module, dubbing and subtitle module, sign language module, voice search module, screenshot/video recording module, sharing module, award list module, directors and actor's module, personalized biological response module and vibration, which make the user experience better.

A contract is signed between the producers of the vision films and the platform, which determines the payment terms and payment percentage. In addition, producers who are members of the platform are allowed to place promotional advertisements on the platform with movie trailer posters, starting 1 month before the release date, for their movies to be released.

Thanks to the vibration module, while watching the movie on a tablet or mobile phone, the phone or tablet vibrates according to the scene according to the action scene in the movie.

Thanks to the pay module, the fees paid during registration on the platform, when renting a movie to watch on the vision date, while making NFT and movie promotional ads are Decisively divided between producers and platform shareholders.

The characteristic features of the products of the invention and the advantages outlined below and all structural shapes, and these shapes by making references to the detailed written description will be understood more clearly and, therefore, must be made in consideration of the evaluation of these figures and detailed description.

### BRIEF DESCRIPTION OF THE DRAWINGS

The invention will be described with reference to the accompanying figures, so that the features of the invention will be more clearly understood and appreciated, but the purpose of this is not to limit the invention to these certain regulations. On the contrary, it is intended to cover all alternatives, changes and equivalences that can be included in the area of the invention defined by the accompanying claims. The details shown should be understood that they are shown only for the purpose of describing the preferred embodiments of the present invention and are presented in order to provide the most convenient and easily understandable description of both the shaping of methods and the rules and conceptual features of the invention. In these drawings.

Figure shows a schematic view of the system.

The figure to help understand the present invention are numbered as indicated in the attached image and are given below along with their names.

### DESCRIPTION OF REFERENCES

10. Terminal
20. Membership Module
21. Producer Membership Module
30. Film Module
31. Sign Language Module
32. Dubbing and Subtitle Module
33. Rating Module
34. Screenshot and Video Recording Module
40. Search Module
41. Voice search Module
42. Director and Actors Module
50. Payment Module
60. Advertising Module
70. NFT Module
71. NFT Creation Module
72. NFT Offer Module
73. NFT Sharing Module
80. Sharing Module
90. Award List Module
100. Personalized Biological Response Module
110. Vibration Module

### DETAILED DESCRIPTION OF THE EMBODIMENTS

The invention, tablet, phone, computer terminal (10), containing information on the nationality of the user, the main language of different languages and know their personal information, hobbies and if you have vision or hearing impairment has an interface where you can register to the platform by entering the appropriate information with the membership module (20), a filmmaker when creating the record for the membership module (20) is integrated with the producer's producer membership module (21), has an interface where information can be entered all the movies you have uploaded to the platform, including the right to membership or rental, they can monitor the results and users to watch movies in the pool that contains the database of film forming film module (30), the user's hearing impairment if you have a module that is included with artificial intelligence algorithms film module (30) in the dialogue and effects in movies with sign language, sign language module (31) that transfers a character, which leads to a corner of the screen, the user's membership module (20) that enters the information, thanks to the dubbing of the film, dubbing and subtitling module (32), audio description and subtitle options that allows the module to be selected automatically or manually, a scoring module that allows the user to handle the rating module (33) after watching the movie the user of a scene in the movie by taking a screenshot or screenshot and video recording module (34) video recording lets you save the until a predetermined time, a movie in order to find the user you want to discover a new movie, year of production, construction and cast, a module that allows you to search topics in categories such as find by searching module (40) and points, and the language used to detect voice commands is written with search criteria and accordingly the original language and subtitle options dubbing of the movie that contains the search module (40) which allows the module to be presented to the user by voice search module (41), a search module (40) the director or the actors aratila appropriate to share personal information, biography, awards, movies, news about the director and the actors module (42) and role of the module that allows it to be viewed by the user the user's system, which he describes as a member of the 3D secure credit card, virtual card, mobile payment, or a payment module that contains a virtual wallet that allows you to make payment module (50) with crypto currency, member of the producers of the platform to be published from 1 month ago from the date of the vision of the film trailer, poster and promotional can publish their ads, advertising module (60) ads, they can do NFT and users created with the handle of the module, users are able to produce NFT, where you can buy and sell NFT module (70), taking a screenshot of a scene in the movie of the user according to user's request immediately or later as a result of the system of NFT creation module (71), allowing for the creation of that scene by NFT user-created crypto currency exchange platform in the markets contracted with NFT sent to the wallet of work, Name, Description and the bid price (to be entered in the necessary permits and the approval of a proposal that allows the module to be sold as a result of NFT offer module (72), the NFT sharing module (73) be shared on other social media platforms prepared NFT, taking a screenshot or video recording of scenes in the movie with other users of users share, likes and comments and sharing module (80) provides an interface that can interact by taking, the sharing module (80) by having to interact with users by using the vote separately for each category and watched a movie after movie of the year by scoring, soundtrack, male and female player, and the prize list is selected in the award list module (90), the user's listening to music, watching videos, location, movements, voice within days, watched the movie and series previously determined as a result of the analysis of mood-appropriate biological response that makes the movie personalized biological response Module (100) to a user that is watching this scene in the movie scene, and according to the intensity of the action as realistic movie experience a mobile device vibrates or tablet that allows you to provide a vibration module (110) is included.

The invention includes a payment module (50) that allows the monthly subscription fee for membership, the rental fee to be able to rent and watch the movie on the date of release, and the fees paid for NFT and movie advertisements, with cash, credit card, mobile payment, virtual card, virtual wallet and crypto money.

The invention includes a payment module (50) that ensures that the payments of the users are collected in the payment pool within it in accordance with the financial legislation, and that it is shared fairly between the filmmakers and the platform shareholders.

The invention includes the NFT module (70), where the NFTs of the characters in the top 5 scenes and scenes from movie posters and movie lines and music that users share the most interaction with are created by the system and sold to users.

The invention of the is basic elements that make up the system terminal (10), the membership module (20), producer membership module (21), film module (30), sign Language Module (31), dubbing and subtitling module (32), the rating module (33), screenshot and Video Recording Module (34), the search module (40), Voice Search Module (41), director and actors module (42), the payment module (50), the advertising module (60), NFT module (70), NFT creation module (71), NFT offer module (72), the sharing module NFT (73), the sharing module (80) award list module (90), personalized biological response module (100) and vibration module (110).

The invention is used with a terminal (10) on devices such as tablets, mobile devices, computers. There is a membership module (20) with an interface where the user can register to the platform by entering personal information such as name, surname, date of birth, gender, mother tongue and different languages, hobbies and, if any, visual or hearing impairment, while registering to the platform. If the registered person is a film producer, there is a producer membership module (21) that provides an interface where different information is requested. There is a film module (30) that creates a database that includes all movies uploaded to the platform and where users can watch movies that they have the right to watch as a result of subscription or rental. By becoming a member of the platform, users have access to movies that can be watched continuously. In addition, the newly released movies can be watched on the vision date or in the following days by paying an extra rental fee. The sign language module (31) ensures that if the user has a hearing impairment, a character that conveys the dialogue and effects in the movies in the movie module (30) with sign language by the artificial intelligence algorithms included in the system appears in a corner of the screen. The dubbing and subtitle module (32) integrated with the movie module (30) enables the dubbing, subtitle and audio description options of the movie to be selected automatically or manually, thanks to the information entered by the user in the membership module (20). There is a rating module (33) that allows the user to score after watching the movie, and a screenshot and video recording module (34) that allows the user to record a scene in the movie by taking a screenshot or video recording for a predetermined time. There is a search module (40) that allows the user to discover a new movie or find a movie she/he wants by searching in categories such as production year, production and cast, subject and rate. In addition, there is a voice search module (41) that allows the search criteria to be written with voice commands and the language used is detected and movies containing the appropriate original language, dubbing and subtitle options are presented to the user by the search module (40). Thanks to the director and actor's module (42) of the director or actor searched in the search module (40), the user can view the personal information suitable for sharing, his biography, the awards he received, the news about him/her and the movies he took part in or shot. 3D security credit card, virtual card, mobile payment or virtual wallet containing crypto money that the user defines to the system while signing up, and the monthly membership fee for membership, the rental fee to rent and watch the movie on the date of release, and the fees paid for NFT and movie advertisements in cash, credit card, mobile also, there is a payment module (50) that enables payment with virtual card, virtual wallet and crypto money. The payment module (50) ensures that the payments of the users are collected in the payment pool within it in accordance with financial legislation, and the fair distribution is made between the filmmakers and the platform shareholders. There is an advertising module (60) where producers who are members of the platform can publish trailers, posters and promotional advertisements starting 1 month before the vision dates of their films, and users can make promotional advertisements of the NFTs they have created. There is an NFT module (70) where the NFTs of the characters in the top 5 scenes, scenes from movie posters, movie lines and music that users share the most interaction with are created by the system and sold to users. Thanks to the NFT creation module (71) included in the NFT module (70), the user takes a screenshot of a scene in the movie, and as a result of the user's request, the NFT of that scene is created by the system immediately or later. There is an NFT offer module (72) that allows the NFTs created by the user to be sent to wallets in the crypto money exchanges contracted with the platform, and sold after entering the title, description and bid price and approving the necessary permissions. There is an NFT sharing module (73), where NFTs prepared on other social media platforms can be shared within the platform. There is a sharing module (80) that provides an interface such as Instagram and Facebook, where users can take screenshots or video recordings of the scenes in the movie, share them with other users, and interact with them by getting likes and comments. The platform includes the award list module (90), in which the movie of the year, soundtrack, male and female actors and scenarios are selected by interacting with the sharing module (80), voting separately for each category by the users, and scoring after watching the movie. The platform includes a personalized biological response module (100) that makes a movie recommendation and reminder according to the mood determined as a result of the analysis of the music the user listens to, the videos he watches, the location movements, the tone of the voice during the day, the movies and TV series he has watched before. There is a vibration module (110) that enables the user to provide a realistic movie experience by vibrating the mobile device or tablet according to the action scene in the movie and the severity of this scene.

What is claimed is:

1. An intelligent platform that contains a terminal of being a tablet, phone, computer in an online and web-based system allowed to be watched and scored movies and create and use a movie-specific Non-Exchangeable Token (NFT), comprising:
a membership module with an interface where a user registers to the intelligent platform by entering his nationality information, personal information, native language, and different languages he knows, hobbies, and information about visual or hearing impairment, if any,
a producer membership module having an interface where producer's information is entered by working integrated with the membership module while a film producer creates a registration,
a film module, configured to create a database that contains all the movies uploaded to the intelligent platform and where users watch movies that they have the right to watch as a result of subscription or rental,
if the user has a hearing impairment, a sign language module, configured to allow a character to appear in a corner of the screen, convey a dialogue and effects in the movies in the film module by artificial intelligence algorithms included in the online and web-based system, with sign language,
a dubbing and subtitle module, configured to enable the dubbing, subtitle and audio description options to be selected automatically or manually, thanks to the information entered by the user in the membership module,
a rating module, configured to allow the user to rate after watching the movie,
a screenshot and video recording module, configured to allow the user to record a scene in the movie by taking a screenshot or video recording for a predetermined period of time,
a search module, configured to allow the user to discover a new movie or find a movie he wants by searching in categories such as production year, production and cast, subject and score,
a voice search module, wherein search criteria in the voice search module are written with voice commands and the language used is detected and movies containing an appropriate original language, dubbing and subtitle options are presented to the user by the search module,
a director and actor's module, configured to allow the user to view the personal information of the director or actor searched in the search module, suitable for sharing, his biography, awards he received, the news about him and the films he took part in or shot,
a payment module, configured to enable the user to make payments with a 3D secure credit card, virtual card, mobile payment, or virtual wallet containing crypto money, which the user defines to the online and web-based system while registering,
an advertising module, wherein in the advertising module, producers as members of the intelligent platform publish trailers, posters and promotional advertisements starting 1 month before the vision dates of their films, and users make promotional advertisements of the NFTs they have created,
an NFT module, wherein in the NFT module, users create and trade NFTs,
an NFT creation module, configured to enable the online and web-based system to create the NFT of that scene immediately or later, according to the user's request, as a result of the user taking a screenshot of a scene in the movie,
an NFT offer module, configured to enable the NFTs created by the user to be sent to wallets in crypto currency exchanges contracted with the intelligent platform, to be sold after entering the title of the work, description and bid price and approving the necessary permissions,
an NFT sharing module, wherein in the NFT sharing module, NFTs prepared on other social media platforms are shared,
a sharing module, configured to provide an interface where users take screenshots or video recordings of the scenes in the movie, share them with other users, and interact with them by getting likes and comments,
an award list module, wherein in the award list module, the movie of the year, soundtrack, male and female actors and screenplays are selected by interacting with the sharing module, voting separately for each category by the users, and scoring after watching the movie,
a personalized biological response module, configured to make movie suggestions and reminders according to the mood determined as a result of an analysis of the music the user listens to, the videos he watches, the location movements, the tone of the voice during the day, the movies and TV series he/she has watched before, and
a vibration module, configured to enable the user to provide a realistic movie experience by vibrating the mobile device or tablet according to the action scene in the movie and the severity of this scene.

2. The intelligent platform according to claim 1, wherein in the payment module, the monthly membership fee for the membership, the rental fee to rent and watch the movie on the date of vision, and the fees paid for NFT and movie advertisements are paid with cash, credit card, mobile payment, virtual card, virtual wallet and crypto money.

3. The intelligent platform according to claim 1, wherein in the payment module, the payments of the users are collected in the database containing a payment pool in accordance with a financial legislation and fairly divided between filmmakers and platform shareholders.

4. The intelligent platform according to claim 1, wherein in the NFT module, the NFTs of the characters in first 5 scenes and scenes from movie posters and movie lines and music that users share the most interaction with are created by the online and web-based system and sold to users.
